(19) United States
(12) Patent Application Publication
(10) Pub. No.: US 2026/0085972 A1
(43) Pub. Date: Mar. 26, 2026

(54) METHOD FOR AUTOMATICALLY DETERMINING A TYPE OF LIGHTING FIXTURE TO WHICH A LIGHTING CONTROLLER IS COUPLED

(71) Applicant: UBICQUIA, INC., FORT LAUDERDALE, FL (US)

(72) Inventors: Robert Patrick Fennell, Deerfield Beach, FL (US); Moises De La Cruz, Cooper City, FL (US); Victor Alejandro Gonzalez, Sunrise, FL (US)

(21) Appl. No.: 19/339,288

(22) Filed: Sep. 24, 2025

Related U.S. Application Data
(63) Continuation-in-part of application No. 19/336,493, filed on Sep. 22, 2025.
(60) Provisional application No. 63/698,362, filed on Sep. 24, 2024.

(51) Int. Cl. G01J 1/42; G01J 1/44

(52) U.S. Cl. CPC G01J 1/4228; G01J 1/44; G01J 2001/4247

(57) ABSTRACT

A processor performs a method for automatically determining a type of lighting fixture to which a lighting controller is coupled. The processor receives, from a first light sensor of the controller, an output signal representative of a first detected luminous flux and, from a second light sensor of the controller, an output signal representative of a second detected luminous flux. The processor compares the magnitudes of the two output signals to produce a comparison result. When the comparison result indicates that the magnitude of the first detected luminous flux is greater than a magnitude of the second detected luminous flux, the processor determines that the lighting fixture is of a first type. When the comparison result indicates that the magnitude of the first detected luminous flux is less than the magnitude of the second detected luminous flux, the processor determines that the lighting fixture is of a second type.

### CROSS-REFERENCE TO RELATED APPLICATIONS

The present application is a continuation-in-part of U.S. application Ser. No. 19/336,493, which was filed on Sep. 22, 2025, and is incorporated herein by this reference as if fully set forth herein. The present application also claims the benefit of and priority upon U.S. Provisional Patent Application No. 63/698,362 , which was filed on Sep. 24, 2024, and is incorporated herein by this reference as if fully set forth herein.

### TECHNICAL FIELD

The present disclosure relates generally to lighting control devices used in or on lighting fixtures and, more particularly, to a method for automatically selecting the type of lighting fixture to which a lighting controller is installed.

### BACKGROUND

Outdoor electronics, Internet of Things (IoT) sensors, industrial IoT sensors, telecommunication equipment, and enclosures are prevalent in telecommunications, industrial, utility, residential, and military fields. One type of outdoor electronics is a lighting controller for roadway lighting, streetlights, parking lot lighting, and park lighting. Some lighting controllers are configured for use with pole-mounted cobra head type lighting fixtures. Such controllers may have light sensing functionality configured near the top centers of the devices to facilitate receipt of ample ambient light by their internal ambient light sensors when the controllers are positioned atop luminaires of the cobra head lighting fixtures. However, such lighting controllers are not as useful when used in decorative type lighting fixtures in which the positioning of the lighting controller is typically perpendicular to the base of the lighting fixture's luminaire instead of at the top of the luminaire.

### SUMMARY

The present disclosure describes exemplary embodiments of electronic devices, light sensing systems, and methods relating to them. According to some embodiments, a processor performs a method for automatically determining a type of lighting fixture to which a lighting controller is coupled. The processor may be included as part of the lighting controller or may be remotely located from the lighting controller, such as part of a cloud-based processing platform. According to such embodiments, the processor receives, from a first light sensor of the lighting controller, a first output signal (e.g., voltage) representative of a first luminous flux detected by the first light sensor. The processor also receives, from a second light sensor of the lighting controller, a second output signal (e.g., voltage) representative of a second luminous flux detected by the second light sensor. Each light sensor may include a conventional ambient light sensor (ALS) circuit including an optical sensor or photodetector (e.g., a light-dependent resistor) and associated circuitry. The processor then compares the magnitude of the first output signal to the magnitude of the second output signal to produce a comparison result. When the comparison result indicates that the magnitude of the first luminous flux is greater than the magnitude of the second luminous flux, the processor determines that the lighting fixture is of a first type (e.g., cobra head type) and may use the first output signal to maintain a lighting schedule for, or otherwise control operation of, the lighting fixture. When the comparison result indicates that the magnitude of the first luminous flux is less than the magnitude of the second luminous flux, the processor determines that the lighting fixture is of a second type (e.g., decorative type) and may use the second output signal to maintain the lighting schedule for, or otherwise control operation of, the lighting fixture. When the comparison result indicates that the difference between the magnitude of the first luminous flux and the magnitude of the second luminous flux is less than a threshold, the processor may use the first output signal and the second output signal to maintain the lighting schedule for, or otherwise control operation of, the lighting fixture. For example, the processor may combine the magnitudes of the first and second output signals to produce a combined input for use in maintaining or applying the lighting schedule for, or otherwise controlling operation of, the lighting fixture. Alternatively, the processor may assign separate weights to the magnitudes of the first and second output signals and use the combined weighted magnitudes to produce a weighted input for use in maintaining or applying the lighting schedule for, or otherwise controlling operation of, the lighting fixture.

According to other exemplary embodiments, the first light sensor may be configured within the lighting controller to be the primary receiver of light when the lighting controller is coupled to the lighting fixture in a first orientation (e.g., vertically or otherwise, such as when coupled to a cobra head lighting fixture) and/or the second light sensor may be configured within the lighting controller to be the primary receiver of light when the lighting controller is coupled to the lighting fixture in a second orientation (e.g., horizontally or otherwise, such as when coupled to a decorative lighting fixture). The first orientation may be an orientation for the lighting controller when coupled to a lighting fixture of the first type (e.g., a cobra head lighting fixture) and the second orientation may be an orientation for the lighting controller when coupled to a lighting fixture of the second type (e.g., a decorative lighting fixture).

According to other embodiments, a processor of a lighting controller performs a method for automatically determining a type of lighting fixture to which the lighting controller is coupled. According to these embodiments, the processor receives, from a first light sensor of the lighting controller, a first output signal (e.g., voltage) representative of a first luminous flux detected by the first light sensor. The processor also receives, from a second light sensor of the lighting controller, a second output signal (e.g., voltage) representative of a second luminous flux detected by the second light sensor. The processor compares the magnitude of the first output signal to the magnitude of the second output signal to produce a comparison result. When the comparison result indicates that the magnitude of the first luminous flux is greater than the magnitude of the second luminous flux, the processor determines that the lighting fixture is of a first type (e.g., cobra head type) and uses the first output signal to maintain a lighting schedule for, or otherwise control operation of, the lighting fixture. When the comparison result indicates that the magnitude of the first luminous flux is less than the magnitude of the second luminous flux, the processor determines that the lighting fixture is of a second type (e.g., decorative type) and uses the second output signal to maintain the lighting schedule for, or otherwise control operation of, the lighting fixture. When the comparison result indicates that the difference between the magnitude of the first luminous flux and the magnitude of the second luminous flux is less than a threshold, the processor uses the first output signal and the second output signal to maintain the lighting schedule for, or otherwise control operation of, the lighting fixture. For example, the processor may combine the magnitudes of the first and second output signals to produce a combined result for use in maintaining or applying the lighting schedule for, or otherwise control operation of, the lighting fixture. Alternatively, the processor may assign separate weights to the magnitudes of the first and second output signals and use the combined weighted magnitudes to produce a weighted result for use in maintaining or applying the lighting schedule for, or otherwise control operation of, the lighting fixture.

According to a further exemplary embodiment, a method for automatically selecting the type of lighting fixture to which a lighting controller is installed may include providing a light sensing system configured to detect the strength of a luminous flux at a first light sensor system and a second light sensor system, each having an output sensing signal; and based on the output sensing signals, choosing the first or the second light sensor system with the higher output signal to supply illuminance data to a processor used for maintaining a lighting schedule for a lighting fixture going forward.

According to another exemplary alternative embodiment, a method for automatically selecting the type of lighting fixture to which a lighting controller is installed includes providing a light sensing system configured to detect the strength of a luminous flux at a first light sensor system and a second light sensor system, each having an output sensing signal; and providing a processor including memory that stores at least processor-readable operating instructions; and at least one processor that is operable in accordance with the processor-readable operating instructions to choose, based on the output sensing signals, the light sensor system with the higher output signal to supply illuminance data to the processor used for maintaining a lighting schedule for the lighting fixture. According to some embodiments, the processor chooses the first light sensor system to supply illuminance data to the processor when the strength of the luminous flux detected by the first light sensor system is higher than the strength of the luminous flux detected by the second light sensor system or chooses the second light sensor system to supply illuminance data to the processor when the strength of the luminous flux detected by the second light sensor system is higher than the strength of the luminous flux detected by the first light sensor system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present disclosure. Some of the elements and features disclosed herein may be viewable in one or more of the figures, but not necessarily in all the figures. The figures of the drawings are not drawn to scale.

FIG. 1 is an exploded view of an electronic device, in accordance with an exemplary embodiment of the present disclosure.

FIG. 2 is an enlarged partial perspective view of a partially translucent (PT) carrier of the electronic device in FIG. 1, in accordance with exemplary embodiments of the present disclosure.

FIG. 3 is an enlarged partial cut-away view along lines 3-3 in FIG. 2, of a partially translucent (PT) carrier of the electronic device in FIG. 1, in accordance with an exemplary embodiment of the present disclosure.

FIG. 4 is an enlarged partial view of a lower section of an inside surface of the PT carrier of the electronic device in FIG. 1, illustrating a smooth rectangular region on the inside surface located between slots, in accordance with an exemplary embodiment of the present disclosure.

FIG. 5 is an enlarged partial view of a lower section of an inside surface of the PT carrier of the electronic device in FIG. 1, illustrating a smooth six-sided region on the inside surface located between slots, in accordance with an exemplary embodiment of the present disclosure.

FIG. 6 is an enlarged partial view of a lower section of an inside surface of the PT carrier of the electronic device in FIG. 1, illustrating inside surface smooth slot walls, in accordance with an exemplary embodiment of the present disclosure.

FIG. 7 is an enlarged partial view of a lower section of an inside surface of the PT carrier of the electronic device in FIG. 1, illustrating light directing action of smooth slot walls in FIG. 6, in accordance with an exemplary embodiment of the present disclosure.

FIG. 8 is a front elevated view of the electronic device in FIG. 1 connected to a support structure, in the form of a decorative light fixture, in accordance with some exemplary embodiments of the present disclosure.

FIG. 9 is a perspective view of an electronic device in FIG. 1 connected to a support structure, in the form of a luminaire, in accordance with some exemplary embodiments of the present disclosure.

### DETAILED DESCRIPTION

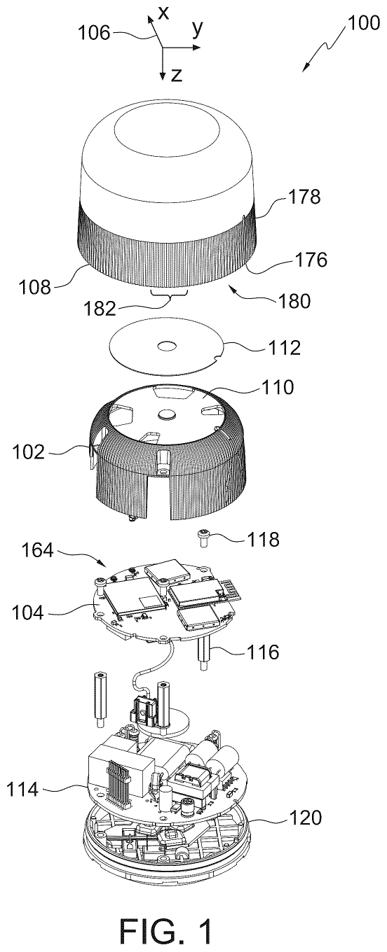

While the specification concludes with claims defining the features of the invention, it is believed that the present disclosure will be better understood from a consideration of the following description in conjunction with the drawing figures. FIG. 1 is an exploded view of an electronic device 100, in accordance with exemplary embodiments of the present disclosure. The electronic device 100 includes, inter alia, a partially translucent (PT) carrier 102, a main printed circuit board (PCB) 104, and other electrical, mechanical, and optical components arranged and configured to enable the electronic device 100 to perform its intended function. More particularly, along a 3D axis system 106 in FIG. 1, the electronic device 100 may include a top cover 108, the PT carrier 102 (which may include a recess in the exterior of its top 110 for receiving an antenna PCB 112), the main PCB 104, a power supply PCB 114, standoffs 116, and fasteners/screws 118 for connecting the main PCB 104 to the standoffs 116, and a base 120 containing a connector, such as a twist-lock connector for roadway lighting compliant with a National Electrical Manufacturers Association (NEMA) specification. The top cover 108, the PT carrier 102, and the main PCB 104 are described in more detail below with respect to the figures.

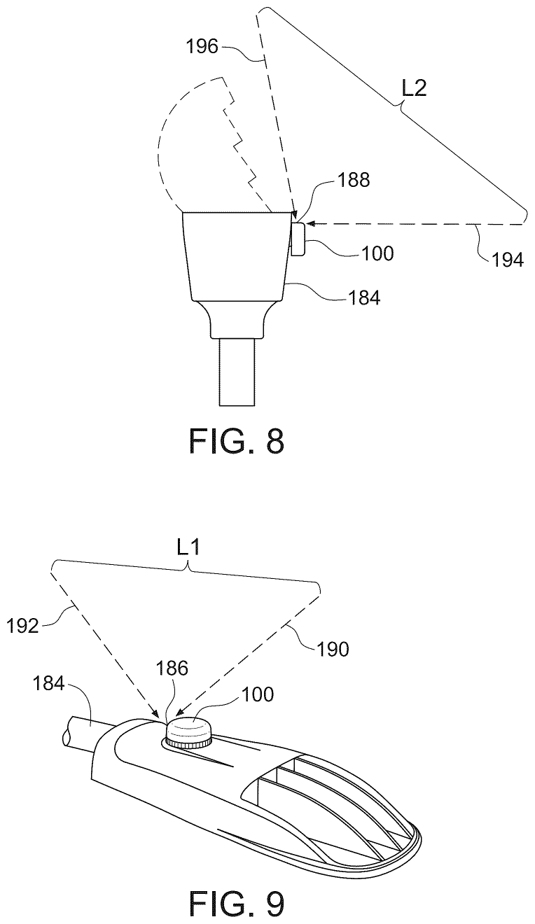

In a simplified exemplary embodiment, in FIGS. 1-3, an electronic device 100 is disclosed. The electronic device 100 can include: a light sensing system 164 including a first sensor 134 and a second sensor 136; and an at least partially translucent (PT) carrier 102 positioned at least partially over the light sensing system 164, the PT carrier 102 configured to allow light impinging on an exterior surface of the PT carrier toward the light sensing system 164. Advantageously, this configuration provides a smarter electronic device that can be seamlessly integrated with ALS functionality, in connection with lighting operations and IoT applications, for example. For example, smart lighting and IoT products with ALS can turn an electronic device off during daylight and on at night or when overcast (or needed). Advantageously, this configuration can the making of a single electronic device that addresses different use cases, such as providing a side mounted electronic device adapted to receiving side detectible light L2 (in FIG. 8) and a top mounted electronic device adapted to receiving above detectible light L1 (in FIG. 9), for example.

In one exemplary embodiment, one or more antennas are disposed at least partially on and/or adjacent to the antenna PCB 112, for enhanced RF reception, for example. The components illustrated on main PCB 104, antenna PCB 112 and power PCB 114, may include various electrical components, including but not limited to a cellular modem, a processor/controller, associated circuitry and input/output connections, power components, IoT components and a GPS receiver, for example. The antennas on antenna PCB 112 are shown on the top and can be routed to a ground plane, for example. Advantageously, this configuration and strategic placement of antenna PCB 112 is intended to be substantially free from interfering or obstructing with the light being directed to a light sensor(s) and/or light guide, and can contribute to the efficiency of the light sensing system,

In one exemplary embodiment, the electronic device 100 can be mounted to a streetlight luminaire that has a National Electrical Manufacturers Association (NEMA) socket in compliance with the American National Standards Institute (ANSI) C136 series of standards or the Zhaga Book 18 standard. Accordingly, in this case the plug 120 and components in electronic device 100 can be in compliance with ANSI and/or Zhaga Book 18 standards.

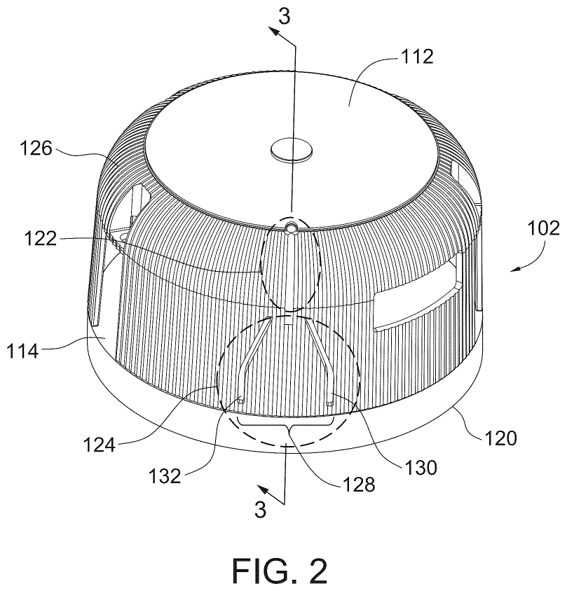

FIG. 2 is an enlarged perspective view of a partially translucent (PT) carrier 102 of the electronic device 100, in accordance with exemplary embodiments of the present disclosure.

The PT carrier 102 in FIG. 2, includes a first (top) light guide 122 and a second (bottom) light guide 124, configured to allow light impinging on an external surface 126 of the PT carrier 102 toward a light sensing system 164. The external surface 126 of the PT carrier 102 can include a plurality of facets 128 generally extending outwardly from the external surface 126, for improved lighting toward at least the second light guide 124.

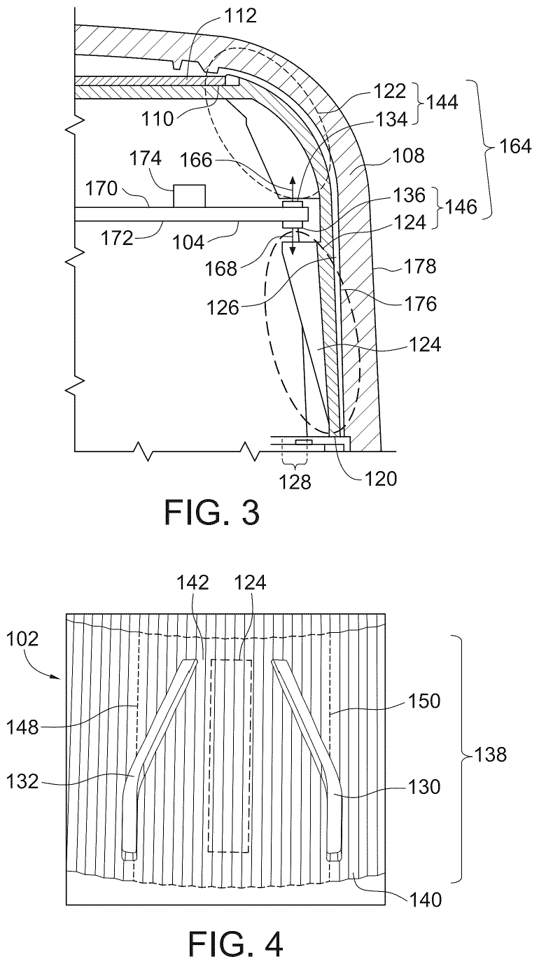

In one exemplary embodiment, the electronic device 100 can be used to detect light from two different orientations, as shown in FIGS. 8 and 9. For example, the first and second sensors 122, 124 can be employed on the top and bottom surfaces 170, 172 of the main PCB 104, as shown in FIG. 3. In one use case, the electronic device 100 needs the ability to detect light from the top or from above, as in the form of a light controller in a cobra head luminaire fixture installation, as shown in FIG. 9, for example. In more detail, the first light guide 122 directs light toward the first sensor 134 at strategic first location 186. In a second use case, the second light guide 124 directs light toward the second sensor 136 below the main PCB 104 (FIG. 3), as in a decorative luminaire fixture installation in FIG. 8, from a side at strategic second location 188. Thus, the electronic device 100 has multiple use cases and can be used in different orientations.

In one exemplary embodiment, in FIG. 2, left and right slots 130, 132 help allow light to travel substantially unobstructed (or minimally) toward the second light guide 124. As used herein and as background, a light guide is generally a device designed to transport light from a light source to a point at some distance with minimal loss. Light is transmitted through a light guide by means of total internal reflection. Light guides are typically made of optical grade materials such as glass, certain plastics, acrylic resin, polycarbonate, epoxies, glass and the like, which typically have an index of refraction around 1.5. Light that is injected into the light guide within the correct range of angles becomes trapped inside the guide because of a phenomenon called total internal reflection (TIR). Once trapped, the light remains inside the guide until it is extracted by an extraction feature, is fully absorbed by the material, or encounters a surface at less than the critical angle. In some exemplary use cases, the goal is to move the light from one end of the guide to the other. In other cases, the goal is to extract the light along the length of the light guide and send it in a specific direction. This makes the light guide appear lit. This extraction can be achieved by adding components to the device like paint dots or textures (small bumps or holes) that influence the way the light is reflected, breaking the TIR condition and causing the light to exit the light guide. By allowing light to travel down the length of a guide while reflecting off the sides, the light is “mixed,” and the light emerging from the end of the light guide is spatially and angularly uniform.

FIG. 3 is an enlarged cut-away view along line 3-3 in FIG. 2, showing the partially translucent (PT) carrier 102, main PCB 104, first and second light guides 122, 124, located adjacent to first and second sensors 134, 136, such as ambient light sensors, in accordance with an exemplary embodiment. In more detail, the PT carrier 102 in FIG. 3, includes a first (top) light guide 122 and a second (bottom) light guide 124, both generally shown as triangular. The PT carrier 102 is configured to allow light impinging on an exterior surface 126 of the PT carrier 102 toward a light sensing system 164, such as first and second light guides 122 and 124. The exterior surface 126 of the PT carrier 102 can include a plurality of facets 128 generally extending outwardly away from the exterior surface 126, for improved lighting toward the first and second light guides 122, 124, as needed. The plurality of facets 128 are configured and located in proximity to light guides 122, 124, to direct light impinging on the exterior surface of the PT carrier 102 toward the light sensing system. Advantageously, the facets 128 are designed and configured to create a prismatic effect that focuses and/or converges a light array to a predetermined target, such as toward the light sensing system 164 and/or at an entrance to a light guide, for example. Advantageously, the plurality of facets 128 can form a Fresnel-like lens to focus impending light on the entrance or input to a light guide 122, 124.

In FIGS. 8 and 9, exemplary use cases are shown configured to allow light impinging on an exterior surface 178 of the top cover 108 through external surface 126 of the PT carrier 102 toward a light sensing system, such as to first and second light guides 122, 124. Such placement of this structure is shown at first and second strategic locations 186 and 188 (shown in FIGS. 8 and 9). Thus, light L1 is received at first strategic location 186 between lines 190 and 192 in FIG. 9 and light L2 at second strategic location 188 between lines 194 and 196 in FIG. 8, in these use cases.

FIG. 4 is an enlarged partial view of a lower section 138 of an inside surface 140 of the PT carrier 102. Also shown is a smooth (finished or polished area) generally rectangular region 142 on the lower section 138 of the inside surface 140 of the PT carrier 102 in FIG. 4. Left and right slots 130, 132 are shown generally extending vertically in proximity to left and right sides 148, 150 of the smooth region 142. The slots 130, 132 can assist in extracting the light along the length of the light guide and send it in a specific direction, such as to an exit facing a sensor. Note that in FIG. 4, since the smooth region 142 is partially translucent, the facets 128 can be seen on the external surface 126.

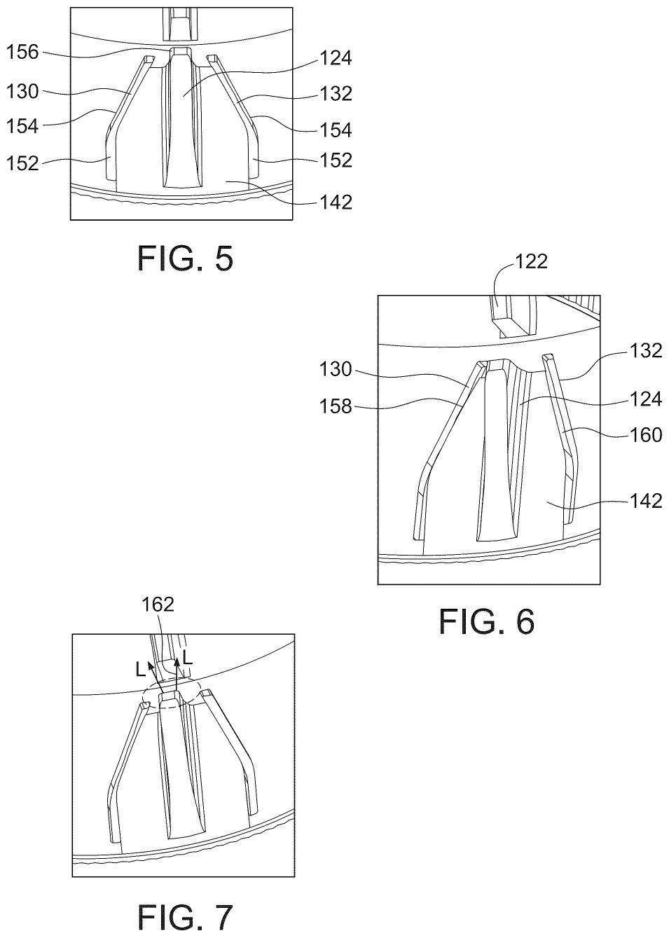

FIG. 5 is an enlarged partial view of the lower section 138 of the inside surface 140 of the PT carrier 102. The smooth region 142 in FIG. 5, is generally a six-sided geometric (or hexagon) section on the lower section 138 of the inside surface 140 of the PT carrier 102. Right and left slots 130, 132 are shown generally extending vertically in proximity to left and right sides 148, 150 of the smooth region 142, each with a vertical section 152 and an angled section 154 adjacent the left side 148 and the right side 150 of the smooth region 142. The second light guard 124 of the PT carrier 102 includes a substantially vertical body section along a z-axis.

FIG. 6 is an enlarged partial view of the lower section 138 of the inside surface 140 of the PT carrier 102. The smooth region 142 on the lower section 138 of the inside surface 140 of the PT carrier 102 is shown. Left and right slots 130, 132 are shown with inside surfaces 158, 160 being smooth, polished or finished. The first and second light guards 122, 124 of the PT carrier 102 are shown, along a z-axis, in accordance with exemplary embodiments of the present disclosure.

FIG. 7 is an enlarged partial view of the lower section 138 of the inside surface 140 of the PT carrier 102. FIG. 7 shows the light directing action of the smooth inside surfaces 158, 160, in accordance with exemplary embodiments of the present disclosure. This shows light can be delivered efficiently and effectively toward a desired target, such as a sensor.

Returning to FIGS. 1-3, the electronic device 100 includes: a light sensing system 164 including a first sensor 134 and a second sensor 136; and an at least partially translucent carrier (PT carrier) 102 positioned at least partially over the light sensing system 164, the PT carrier 102 configured to allow light impinging on an exterior surface 126 of the PT carrier 102 toward the light sensing system 164, preferably to a light guide thereof.

In FIGS. 1-3, the electronic device 100 further includes a main PCB 104 including the light sensing system 164 connected thereto including the first sensor 134 being orientated at a first direction 166 and the second sensor 136 being orientated at a second direction 168 different from the first sensor 166. The different orientations can allow ambient or sunlight to be detected from different directions, such as from a top or side of the PT carrier 102, for example. In one exemplary embodiment, the first sensor 134 can be aimed at a first direction 166 and the second sensor 136 can be aimed at a second direction 168 substantially opposite from the first direction 166, as shown in FIG. 3. Thus, in one exemplary use case, the first sensor 134 can be coupled to the top surface (in phantom in FIG. 3) 170 of the main PCB 104 and the second sensor 136 on the bottom surface 172 (in phantom), such that light can be sensed from a top or side of a PT carrier 102, for example.

In FIGS. 1-3, the electronic device 100 further shows the light sensing system 164 with a first light guide 122 and a second light guide 124 configured to be adjacent to and guide light to the first and the second sensors 134, 136, respectively. This structure can help provide enhanced light detection at the sensors 134, 136, for example, for enhanced light entry to the sensor(s) depending on different orientations or use cases.

Continuing, the first lightguide 122 and the second lightguide 124 are connected to the PT carrier 102, providing a secure structure for enhanced light detection to the sensors 134, 136. In one exemplary embodiment, the first and second lightguides 122, 124 are molded in the PT carrier 102 or otherwise integrated therein or thereto. This configuration can help provide enhanced light detection, secure positioning adjacent to the sensors 134, 136 and a robust structure for enhanced optical efficiency and extended useful life.

In one exemplary embodiment, the light sensing system 164 includes at least one light guide configured to direct light impinging on an external surface 126 of the PT carrier 102 toward at least one sensor entrance. In one embodiment, it has the first and second light guides 122, 124, for example. In FIG. 3, the processor 174 can be positioned on the main PCB 104 and can be coupled to at least one of the first and second light sensors 134, 136. The processor 174 is operable to generate a lighting control signal responsive to receipt of a light sensing signal from the at least one of the first and second light sensors 134, 136. Referring to FIG. 3, as should be understood, various inputs and outputs can be connected to the sensors, antennas, power components and circuitry associated with the PCBs 104, 112, 114, for example. As should be understood, the processor 174 in FIG. 3 can include inputs and outputs connected to associated circuitry, components and the sensors, for the proper operation of electronic device 100, for example. These details are not shown.

In an exemplary embodiment, the electronic device 100 may include a controller and may provide Internet of Things functionality (IoT). The IoT functionality can include power metering and transmitting the results via wireless communication to a data center for billing, in connection with potential use cases. The electronic device 100 may be a networked lighting controller in a smart city lighting system and/or an IoT sensor, for example.

In one exemplary embodiment in FIGS. 2 and 3, the PT carrier 102 includes a plurality of facets 128 which are interconnected and generally evenly distributed along the external surface 126 of the PT carrier 102 substantially adjacent to the second sensor 136 and second lightguide 124, for improved light capture directed to the second light guide 124. In one exemplary embodiment, at least some of the facets 128 are arranged in pairs and wherein each pair of facets is triangularly shaped. In another exemplary embodiment, each facet 128 is angled in a range of about three degrees to about five degrees relative to a reference axis, such as a z-axis, for example. The facets 128 can be integrated with or otherwise molded into the external surface 126 of the PC carrier 102, for example.

In one exemplary embodiment in FIG. 4, the PC carrier 102 includes an inside surface 140 having a smooth (polished or finely finished) region 142 configured in proximity to at least one of the first and second light guides 122 and 124, preferably at least the second light guide 124, for improved optics and/or light transmission. FIG. 4 also shows a generally rectangular smooth region 142, with left and right slots 130, 132 on an inside surface 140 and a plurality of facets 128 on the external surface 126. This structure can help to provide enhanced and minimally obstructed light, where desired, such as to the second light guide 124 and then through the second light guide 124 to the second sensor 136, for example.

In FIG. 4, the PT carrier 102 includes an inside surface 140 having left and right slots 130, 132 in proximity to the smooth region 142 and second light guide 124, generally parallel to a z-axis and the second light guide 124, for enhanced optics.

In FIG. 5, the PT carrier 102 includes an inside surface 140 having left and right slots 130, 132 in proximity to the left and right sides 148, 150 of smooth region 142, which are generally parallel to a z-axis. In FIG. 5, the smooth region 142 is generally a six-sided region or hexagonal in shape, with the second light guide 124 generally configured and located in the middle, for enhanced optics and light flow (travel) toward and along the second light guide 124.

In FIG. 6, the slots 130, 132 include inside wall surfaces 158, 160 being substantially smooth, such as by being polished, finely finished and the like. The inside surfaces 158, 160 help to allow light to travel toward the second light guide 124 and improved lighting to the second light guide 124. FIG. 7 shows light directing action of the slots 130, 132 and inside surfaces 158, 160 thereof.

Referring back to FIGS. 1 and 3, the electronic device 100 includes a top cover 108, which may be at least partially translucent and dome shaped with an open bottom 180 complementarily configured to receive the PT carrier 102. In one exemplary embodiment, the top cover 108 includes an interior surface 176 including a plurality of facets 182 configured to direct light impinging on the exterior surface 178 toward a desired location within the top cover 108, such as in proximity to a light guide, such as the second light guide 124 shown in FIG. 3. Beneficially, the facets 182 can create a prismatic effect that focuses or converges a light array to a predetermined target, such as toward the light sensing system 164 and/or preferably at an entry to a light guide, for example. Further, the plurality of facets 182 can form a Fresnel-like lens to focus impending light, on the entrance to a light guide and through PT carrier 102, for example.

In one exemplary embodiment, the exterior surface 178 of the top cover 108 can include a generally smooth exterior surface 178. In another exemplary embodiment, the top cover 108 can have a generally irregular surface, such as a faceted, grooved, abrasive, or curved surface, for enhanced handling, gripping for installation, removal or maintenance, as appropriate.

FIG. 8 is an elevational view of a support structure 184, such as a decorative one, to which an electronic device 100 is attached or mounted to. In more detail, as shown in FIG. 3, the PT carrier 102 includes a first (top) light guide 122 and a second (bottom) light guide 124, located at first and second strategic locations 186, 188 (shown in FIGS. 8 and 9), for improved capture of external ambient lighting and eventual directing of such lighting toward the first and second light guides 122 and 124 (in FIG. 3). More specifically, light L1 is received at first strategic location 186 between lines 190 and 192 in FIG. 9 and light L2 at second strategic location 188 between lines 194 and 196 in FIG. 8.

FIG. 9 illustrates another exemplary embodiment in which the electronic device 100 is mounted to a support structure 304, such as to a streetlight luminaire. This connection structure can be in compliance with roadway lighting connection standards, such as the ANSI C136 series of standards or the Zhaga Book 18 standard. In an exemplary embodiment, the electronic device 100 may include a controller, antennas, modems, circuits and other electronic componentry to provide Internet of Things functionality (IoT). The IoT functionality can include power metering and transmitting the results via wireless communication to a data center for billing, in connection with the use cases in FIGS. 8 and 9, for example. The electronic device 100 may be a networked lighting controller in a smart city lighting system and/or an IoT sensor.

In one exemplary alternative embodiment in FIGS. 1 and 3, the electronic device 100, can be in the form of a lighting control device. The electronic device can include: a light sensing system 164; a processor 174 coupled to the light sensing system 164 and operable to generate a lighting control signal responsive to receipt of a light sensing signal from the light sensing system 164; and an at least PT carrier 102 positioned at least partially over the light sensing system 164, including an inside surface 140 and an external surface 126, the external surface 126 of the PT carrier 102 including a plurality of facets 128 configured to direct light impinging on the external surface 126 toward the light sensing system 164, preferably such as to a light guide and then sensor, for example. Advantageously, the facets 128 can be configured to create a prismatic effect that focuses or converges a light array to a predetermined target, such as toward the light sensing system 164 and/or preferably at an entry to a light guide, for example. Further, the plurality of facets 128 can form a Fresnel-like lens to focus impending light, on the entrance or input to a light guide.

In one exemplary embodiment, the main PCB 104 includes the light sensing system connected thereto including a first sensor 134 being orientated at a first direction and a second sensor 136 being orientated at a second direction different from the first sensor 134. In one exemplary embodiment, the PT carrier 102 includes a first light guide 122 and a second light guide 124 molded, attached or integrated therein or thereto. This configuration can help provide enhanced light detection and a secure and robust structure for a long useful life.

In one exemplary embodiment, the light sensing system 164 includes a light sensor and wherein a plurality of facets 128 are configured to direct light impinging on the external surface 126 of the PT carrier 102 toward a light guide, such as the second light guide 124, for example.

In one exemplary embodiment, in FIG. 10, a block diagram of a method for automatically selecting the type of lighting fixture to which a lighting controller is installed, is shown. The method can include providing a light sensing system 163 configured to detect the strength of a luminous flux at, at least a first and a second light sensor system 164, 165 each having an output sensing signal; and based on the output sensing signals, choosing the first or the second light sensor system with the higher output signal to supply illuminance data to a processor used for maintaining a lighting schedule for a lighting fixture going forward. Advantageously, the method allows one product to be used for different use cases, as shown in FIGS. 8 and 9, for example. Advantageously, this can provide a simple, reliable and robust method for configuring a light controller.

In more detail, the choosing step of the first or the second light sensor system 164, 165 can include choosing the first light sensor system 164 if the detected strength of the luminous flux is higher than that of the second light sensor system 165 or choosing the second light sensor system 165 if the detected strength of the luminous flux is higher than that of the first light sensor system 164. This provides an automated process for installation and configuration, for example.

In one exemplary embodiment, the method can include a processer configured to apply a predetermined lighting program for the chosen light sensor system. This is a beneficial feature, as the chosen light sensor can have different operating specifications for operating a light, lamp, or LED, for example, than the unchosen light sensor system.

Referring to FIGS. 8 and 9, the first light sensor system detects light from substantially above an electronic device and the second light sensor system detects light from substantially a side of an electronic device. Advantageously, this configuration allows the making of a single product that addresses two different use cases, such as those in FIGS. 8 and 9. For example, a side mounted electronic device is shown in FIG. 8 which could detect light L2 and a top mounted product is shown in 9 which detects light L1.

In one exemplary embodiment, the method in FIG. 10 can further comprise a step of configuring and locating the first light sensor system 144 to detect light from substantially above at L1 an electronic device 100 (in FIG. 9) and the second light sensor system 146 detecting light from substantially a side at L2 (in FIG. 8) of the electronic device 100, by first and second strategic locations 186, 188, in FIGS. 8 and 9. In more detail, the first light sensor system 144 can detect light L1 from a first direction between phantom light lines 190 and 192 (in FIG. 9) and the second light sensor system 146 can detect light L2 from a second direction between phantom light lines 194 and 196 (in FIG. 8).

In one exemplary embodiment, the method can further comprise generating a fault signal when the detected strength of a luminous flux at the first and the second light sensor systems 144, 146 are within a predetermined threshold of each other. This fault signal can indicate that the choosing step was not completed. In such an event, the choosing step should be repeated or a manual setting should be set to make the correct choice.

In another exemplary embodiment in FIG. 3, the method can further comprise providing the first and the second light sensor systems 144, 146 with light guides 122, 124 configured to guide light to a first and a second sensor 134, 136 located adjacent thereto.

In FIG. 3, the processor 174 is operable to generate a lighting control signal responsive to receipt of the outputted sensing signal of the light sensing system, the lighting control signal being usable by a lamp driver of a lamp, as shown in FIGS. 8 and 9, for example. Further use cases, for example, can include the lighting controller being in the form of an electronic device including at least one of monitoring, sensing, and Internet of Things functionality.

In another exemplary embodiment, a method for automatically selecting the type of lighting fixture to which a lighting controller is installed. The method can include providing a light sensing system configured to detect the strength of a luminous flux at, at least a first and a second light sensor system 144, 146 each having an output sensing signal; and providing a processor 174 comprising: memory that stores at least processor-readable operating instructions; and at least one processor that is operable in accordance with the processor-readable operating instructions to: based on the output sensing signals, choosing the first or the second light sensor system 144, 146 with the higher output signal to supply illuminance data to the processor. Advantageously, the chosen light sensor system can be used for maintaining a lighting schedule for a lighting fixture.

In an exemplary embodiment, the method can include applying a predetermined lighting program for the chosen light sensor system; detecting light L1 (in FIG. 9) from at least one of the first light sensor system from substantially above an electronic device and the second light sensor system from substantially a side (detectable light L2 in FIG. 8) of an electronic device; detecting light from at least one of the first light sensor system 144 from substantially above an electronic device via a first light guide and first sensor, and the second light sensor system 146 from substantially a side of an electronic device via a second light guide and second sensor; configuring and locating the first light sensor system 144 to detect light L1 from substantially above an electronic device and the second light sensor system 146 to detect light L2 from substantially a side of the electronic device, the location can be in proximity to an edge of a PCB 104 near the PC carrier 102, for example. Some use cases for the method can include monitoring, sensing, lighting control, and IoT functionality.

According to some embodiments, a processor 174 performs a method for automatically determining a type of lighting fixture 184, 304 to which a lighting controller 100 is coupled. The processor 174 may be included as part of the lighting controller 100 (as shown in exemplary form in FIG. 3) or may be remotely located from the lighting controller 100, such as part of a cloud-based processing platform. According to such embodiments, the processor 174 receives, from a first light sensor 134 of the lighting controller 100, a first output signal (e.g., voltage) representative of a first luminous flux detected by the first light sensor 134. The processor 174 also receives, from a second light sensor 136 of the lighting controller 100, a second output signal (e.g., voltage) representative of a second luminous flux detected by the second light sensor 136. Each light sensor 134, 136 may include a conventional ambient light sensor (ALS) circuit including an optical sensor or photodetector (e.g., a light-dependent resistor) and associated circuitry. The processor 174 then compares the magnitude of the first output signal to the magnitude of the second output signal to produce a comparison result. When the comparison result indicates that the magnitude of the first luminous flux is greater than the magnitude of the second luminous flux, the processor 174 determines that the lighting fixture 184 is of a first type (e.g., cobra head type) and may use the first output signal to maintain a lighting schedule for, or otherwise control operation of, the lighting fixture 184. When the comparison result indicates that the magnitude of the first luminous flux is less than the magnitude of the second luminous flux, the processor 174 determines that the lighting fixture 304 is of a second type (e.g., decorative type) and may use the second output signal to maintain the lighting schedule for, or otherwise control operation of, the lighting fixture 304. When the comparison result indicates that the difference between the magnitude of the first luminous flux and the magnitude of the second luminous flux is less than a threshold, the processor 174 may use the first output signal and the second output signal to maintain the lighting schedule for, or otherwise control operation of, the lighting fixture 184, 304. For example, the processor 174 may combine the magnitudes of the first and second output signals to produce a combined input for use in maintaining or applying the lighting schedule for, or otherwise controlling operation of, the lighting fixture 184, 304. Alternatively, the processor 174 may assign separate weights to the magnitudes of the first and second output signals and use the combined weighted magnitudes to produce a weighted input for use in maintaining or applying the lighting schedule for, or otherwise controlling operation of, the lighting fixture 184, 304.

According to other exemplary embodiments, the first light sensor 134 may be configured within the lighting controller 100 to be the primary receiver of light when the lighting controller 100 is coupled to the lighting fixture 304 in a first orientation (e.g., vertically or otherwise, such as when coupled to a cobra head lighting fixture) and/or the second light sensor 136 may be configured within the lighting controller 100 to be the primary receiver of light when the lighting controller 100 is coupled to the lighting fixture 184 in a second orientation (e.g., horizontally or otherwise, such as when coupled to a decorative lighting fixture). The first orientation may be an orientation for the lighting controller 100 when coupled to a lighting fixture 304 of the first type (e.g., a cobra head lighting fixture) and the second orientation may be an orientation for the lighting controller 100 when coupled to a lighting fixture 184 of the second type (e.g., a decorative lighting fixture).

Although the present disclosure illustrates and describes several exemplary embodiments for an electronic device and light sensing system, the disclosure is, nevertheless, not intended to be limited to the details shown because various modifications and structural changes may be made to the disclosed embodiments without departing from the spirit of the disclosure and while remaining within the scope and range of equivalents of the appended claims. Additionally, well-known elements of the disclosed embodiments will not be described in detail or will be omitted so as not to obscure the relevant details of such embodiments.

Features that are considered characteristic of the invention are set forth in the appended claims. As required, some detailed embodiments are disclosed herein; however, it is to be understood that the disclosed embodiments are merely exemplary, and the housing or cover may be embodied in various forms. Therefore, specific structural and functional details disclosed herein are not to be interpreted as limiting, but merely as a basis for the claims and as a representative basis for teaching one of ordinary skill in the art to variously employ the claimed invention in appropriately detailed structures. Further, the terms and phrases used herein are not intended to be limiting; but rather, to provide an understandable description of the disclosure.

The terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “comprises,” includes,” “contains,” and “has,” and their respective formatives as used in the present disclosure and the appended claims are intended to be open-ended or non-exhaustive (i.e., open language) and should be interpreted as if each was followed by the words “but is not limited to.” The term “coupled,” as used herein, is defined as connected, although not necessarily directly, and not necessarily mechanically. The term “providing” is defined herein in its broadest sense (e.g., bringing/coming into physical existence, making available, and/or supplying to someone or something, in whole or in multiple parts at once or over a period of time).

As used in this description, unless otherwise specified, azimuth or positional relationships indicated by terms such as “up”, “down”, “left”, “right”, “inside”, “outside”, “front”, “back”, “head”, “tail,” “base,” “cover” and so on, are azimuth or positional relationships based on the drawings or to identify elements or objects, and are only intended to facilitate the descriptions of the disclosed embodiments of the present disclosure, but not to indicate or imply that the elements or objects must have a specific azimuth, or be constructed or operated in the specific azimuth. Furthermore, terms such as “first”, “second,” “third,” and so on are only used for identification purposes and should not be construed as indicating or implying any relative importance or order.

As used in the present disclosure and the appended claims, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected or may be indirectly connected via an intermediate medium. As used in the present disclosure and the appended claims, the term “longitudinal” should be understood to mean in a direction corresponding to an elongated direction of the device.

The terms “about,” “substantially,” “generally,” or “approximately” apply to all numeric values, whether or not explicitly indicated. When used expressly or impliedly in the present disclosure and the appended claims, such terms refer to a range of values, quantities, features, and/or functionality that one of ordinary skill in the art would consider equivalent to the recited values, quantities, features, and/or functionality (e.g., would provide an equivalent result). In many instances these terms may include numbers that are rounded to the nearest significant figure. Those skilled in the art will readily understand the specific meanings of the above-mentioned terms in the embodiments of the present disclosure according to the specific circumstances.

The claims appended hereto are meant to cover all modifications and changes within the scope and spirit of the present disclosure.

What is claimed is:

1. A method for a processor to automatically determine a type of lighting fixture to which a lighting controller is coupled, the method comprising:
receiving, from a first light sensor of the lighting controller, a first output signal representative of a first luminous flux detected by the first light sensor;
receiving, from a second light sensor of the lighting controller, a second output signal representative of a second luminous flux detected by the second light sensor;
comparing a magnitude of the first output signal to a magnitude of the second output signal to produce a comparison result;
when the comparison result indicates that a magnitude of the first luminous flux is greater than a magnitude of the second luminous flux, determining that the lighting fixture is of a first type; and
when the comparison result indicates that the magnitude of the first luminous flux is less than the magnitude of the second luminous flux, determining that the lighting fixture is of a second type.

2. The method of claim 1, further comprising:
when the comparison result indicates that the magnitude of the first luminous flux is greater than the magnitude of the second luminous flux, using the first output signal to maintain a lighting schedule for the lighting fixture.

3. The method of claim 2, further comprising:
when the comparison result indicates that the magnitude of the first luminous flux is less than the magnitude of the second luminous flux, using the second output signal to maintain the lighting schedule for the lighting fixture.

4. The method of claim 1, further comprising:
when the comparison result indicates that the magnitude of the first luminous flux is less than the magnitude of the second luminous flux, using the second output signal to maintain a lighting schedule for the lighting fixture.

5. The method of claim 1, wherein the lighting controller includes the processer.

6. The method of claim 1, wherein the lighting controller is remotely located from the processer.

7. The method of claim 1, wherein the first light sensor is configured within the lighting controller to be a primary receiver of light when the lighting controller is coupled to the lighting fixture in a first orientation.

8. The method of claim 7, wherein the second light sensor is configured within the lighting controller to be the primary receiver of light when the lighting controller is coupled to the lighting fixture in a second orientation.

9. The method of claim 8, wherein the first orientation is an orientation for the lighting controller when coupled to a lighting fixture of the first type and wherein the second orientation is an orientation for the lighting controller when coupled to a lighting fixture of the second type.

10. The method of claim 1, wherein the second light sensor is configured within the lighting controller to be a primary receiver of light when the lighting controller is coupled to the lighting fixture in a predetermined orientation.

11. The method of claim 1, further comprising
when the comparison result indicates that a difference between the magnitude of the first luminous flux and the magnitude of the second luminous flux is less than a threshold, using the first output signal and the second output signal to maintain a lighting schedule for the lighting fixture.

12. A method for a processor of a lighting controller to automatically determine a type of lighting fixture to which the lighting controller is coupled, the method comprising:
receiving, from a first light sensor of the lighting controller, a first output signal representative of a first luminous flux detected by the first light sensor;
receiving, from a second light sensor of the lighting controller, a second output signal representative of a second luminous flux detected by the second light sensor;
comparing a magnitude of the first output signal to a magnitude of the second output signal to produce a comparison result;
when the comparison result indicates that a magnitude of the first luminous flux is greater than a magnitude of the second luminous flux, determining that the lighting fixture is of a first type and using the first output signal to maintain a lighting schedule for the lighting fixture;
when the comparison result indicates that the magnitude of the first luminous flux is less than the magnitude of the second luminous flux, determining that the lighting fixture is of a second type using the second output signal to maintain the lighting schedule for the lighting fixture; and
when the comparison result indicates that a difference between the magnitude of the first luminous flux and the magnitude of the second luminous flux is less than a threshold, using the first output signal and the second output signal to maintain the lighting schedule for the lighting fixture.

13. The method of claim 12, wherein the first light sensor is configured within the lighting controller to be a primary receiver of light when the lighting controller is coupled to the lighting fixture in a first orientation.

14. The method of claim 13, wherein the second light sensor is configured within the lighting controller to be the primary receiver of light when the lighting controller is coupled to the lighting fixture in a second orientation.

15. The method of claim 14, wherein the first orientation is an orientation for the lighting controller when coupled to a lighting fixture of the first type and wherein the second orientation is an orientation for the lighting controller when coupled to a lighting fixture of the second type.

16. The method of claim 12, wherein the second light sensor is configured within the lighting controller to be a primary receiver of light when the lighting controller is coupled to the lighting fixture in a predetermined orientation.
